(19) United States
(12) Patent Application Publication
(10) Pub. No.: US 2022/0140563 A1
(43) Pub. Date: May 5, 2022

(54) OPTICAL DEVICE AND LASER APPARATUS

(71) Applicant: Fujikura Ltd., Tokyo (JP)

(72) Inventors: Tomoki Funatsu, Sakura-shi (JP); Kenichi Ohmori, Sakura-shi (JP); Kensuke Shima, Sakura-shi (JP)

(73) Assignee: Fujikura Ltd., Tokyo (JP)

(21) Appl. No.: 17/431,031

(22) PCT Filed: Feb. 20, 2020
(86) PCT No.: PCT/JP2020/006676

§ 371 Date: Aug. 13, 2021

(30) Foreign Application Priority Data
Feb. 20, 2019 (JP) 2019-028636

(51) Int. Cl. H01S 3/08; G02B 6/036; H01S 3/04; H01S 3/067; H01S 3/094

(52) U.S. Cl. CPC H01S 3/08009; H01S 3/08013; H01S 3/094011; H01S 3/0405; H01S 3/067; G02B 6/036

(57) ABSTRACT

An optical device includes a core, a first cladding, a second cladding, a slanted fiber Bragg grating, and a high refractive index material. The first cladding covers the core and has a lower refractive index than the core. The second cladding covers the first cladding and has a lower refractive index than the first cladding. The slanted fiber Bragg grating is formed in the core and couples stimulated Raman scattering light, propagating through the core, to the first cladding. The high refractive index material has a higher refractive index than the second cladding and covers an outer peripheral surface of a removal portion where the second cladding is removed and a portion of the first cladding that covers the region where the slanted fiber Bragg grating is formed in the core.

### CROSS-REFERENCE TO RELATED APPLICATIONS

This is a national phase application of International Patent Application No. PCT/JP2020/006676 filed Feb. 20, 2020, which claims priority to Japanese Patent Application No. 2019-028636 filed Feb. 20, 2019. The full contents of these applications are incorporated herein by reference.

### TECHNICAL FIELD

The present invention relates to an optical device and laser apparatus.

### BACKGROUND

Currently, laser apparatuses are used in various fields such as processing fields, automobile fields, and medical fields. In recent years, in the processing field, a fiber laser apparatus having excellent beam quality and light-collecting property as compared with a conventional laser apparatus (for example, a carbon dioxide gas laser apparatus) has attracted attention. The maximum output of such a fiber laser apparatus is limited by Stimulated Raman scattering (SRS) that occurs non-linearly with respect to the laser output.

The following Patent Document 1 discloses a technique for reducing SRS light by forming a slanted Fiber Bragg Grating (FBG) in the core of a fiber laser apparatus. According to such a technique, SRS light can be selectively removed from the light propagating in the core. As a result, it is possible to stabilize the signal light propagating in the core and prevent damage to the excitation light source.

### Patent Document

[Patent Document 1] U.S. Pat. No. 9634462

In a high-power fiber laser apparatus, when a slanted FBG is formed on the core, high-power SRS light removed from the core is guided in the cladding. When high-power SRS light is intensively applied to, for example, the protective coating covering the cladding, it is possible that the protective coating generates heat and burns out. Alternatively, when SRS light guided in the cladding reaches the excitation light source, the excitation light source may be damaged.

In addition, in a high-power fiber laser apparatus, when a slanted FBG is formed on the core, it is conceivable that a portion of the signal light propagating in the core leaks to the cladding and is guided in the cladding. When such signal light is applied to, for example, the protective coating covering the cladding, it is possible that the protective coating generates heat and burns out, as in the case where high-power SRS light is intensively irradiated.

### SUMMARY

The present invention has been made in view of the above circumstances, and an optical device and a laser apparatus are provided that are capable of preventing the protective coating from burning out due to heat generation by effectively removing the light guided in the cladding when a slanted FBG is formed on the core.

An optical device (14) according to one or more embodiments includes a core (20a), a first cladding (20b) that covers the core and has a lower refractive index than the core, a second cladding (20c) that covers the first cladding and has a lower refractive index than the first cladding, a slanted FBG (14a) that is formed in the core and couples SRS light propagating through the core to the first cladding, and a high refractive index material (21) that has a higher refractive index than the second cladding and which covers an outer peripheral surface of a removal portion (PT2) where the second cladding is removed and a portion (PT1) of the first cladding which covers the region where the slanted FBG is formed in the core.

In the optical device according to one or more embodiments, the high refractive index material may have a higher refractive index than the first cladding.

The optical device according to one or more embodiments may include a heat dissipation member (22) that covers the high refractive index material.

In the optical device according to one or more embodiments, the heat dissipation member may dissipate heat generated by absorption of SRS light and signal light through the high refractive index material.

The optical device according to one or more embodiments may further include a reinforcement member (23) provided between the heat dissipation member and the second cladding outside of both ends of the removal portion in a longitudinal direction of the first cladding, where the heat dissipation member is formed longer than the length of the removal portion in the longitudinal direction of the first cladding.

The optical device according to one or more embodiments may include at least one cladding mode removal portion (14b) that removes cladding mode light, which includes SRS light coupled from the core to the first cladding by the slanted FBG, from the inside of the first cladding.

A laser apparatus (1, 2) according to one or more embodiments may include an excitation light source (11a, 11b) that emits excitation light, a resonator (13) that generates signal light that is laser light by the excitation light emitted from the excitation light source, and an optical device (14) according to any one of the above that is arranged between the resonator and the output end (15) of the signal light.

In the laser apparatus according to one or more embodiments, the optical device may be arranged in a region where the residual excitation light of the excitation light emitted from the excitation light source substantially does not reach.

In the laser apparatus according to one or more embodiments, the laser apparatus may be a bidirectional excitation fiber laser apparatus including a forward excitation light source (11a) and a backward excitation light source (11b) as the excitation light source, and may include a first combiner (12a) provided between the resonator and the forward excitation light source and a second combiner (12b) provided between the resonator and the backward excitation light source, and the region is a portion located on the output end side of the second combiner.

In the laser apparatus according to one or more embodiments, the laser apparatus may be a forward excitation fiber laser apparatus, the resonator (13) may include an amplification fiber (13a) in which an active element activated by excitation light is added to the core, a first FBG (13b) provided between the first end of the amplification fiber and the excitation light source, and a second FBG (13c) provided between the second end of the amplification fiber and the output end, and the region is closer to the output end side than the second FBG.

According to one or more embodiments, when a slanted FBG is formed on the core, it is possible to effectively remove light guided in the cladding and prevent the protective coating from burning out due to heat generation.

### BRIEF DESCRIPTION OF THE DRAWINGS

FIG. 1 is a diagram showing a main structure of a laser apparatus according to one or more embodiments.

FIG. 2 is a cross-sectional view showing a portion of an optical device according to one or more embodiments.

FIG. 3 is a diagram showing a relationship between a wavelength difference and a refractive index n of a high refractive index material in one or more embodiments.

FIG. 4 is a diagram schematically showing a traveling path of signal light reflected by a slant FBG in one or more embodiments.

FIG. 5 is a cross-sectional view showing a modification of an optical device according to one or more embodiments.

FIG. 6 is a diagram showing a modification of a laser apparatus according to one or more embodiments.

FIG. 7 is a diagram showing a main structure of a laser apparatus according to one or more embodiments.

FIG. 8 is a diagram showing a modification of a laser apparatus according to one or more embodiments.

### DETAILED DESCRIPTION

Hereinafter, the optical device and the laser apparatus according to one or more embodiments will be described in detail with reference to the drawings. In addition, in the drawings used in the following description, for the sake of clarity, characteristic portions may be enlarged and shown, and the dimensional ratios and the like of each component may not be the same as the actual ones. In addition, the present invention is not limited to the following embodiments.

### (Laser Apparatus)

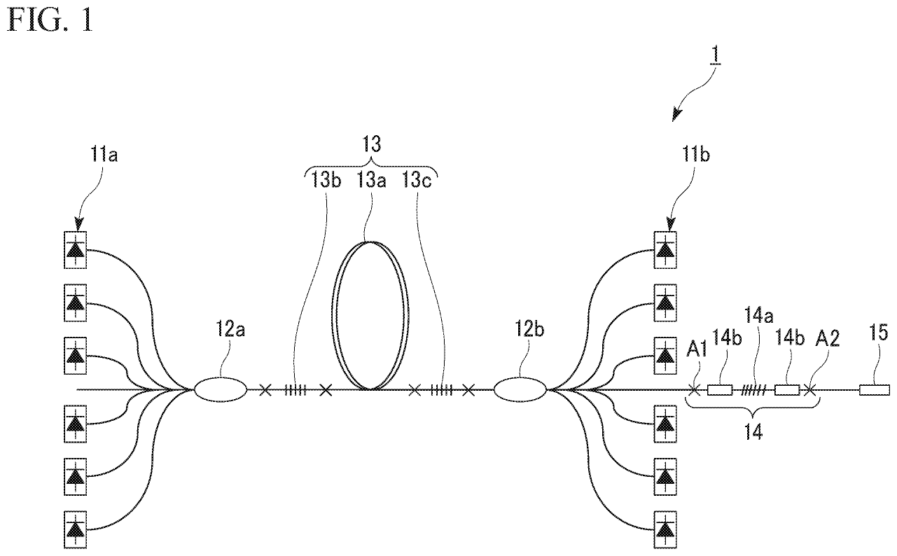

FIG. 1 is a diagram showing one or more embodiments of a laser apparatus. As shown in FIG. 1, the laser apparatus 1 of or more embodiments includes an excitation light source (forward excitation light source) 11a, an excitation light source (backward excitation light source) 11b, a first combiner 12a, a second combiner 12b, a resonator 13, an optical device 14, and an output end 15. Such a laser apparatus 1 is a bidirectional excitation fiber laser apparatus including an excitation light source 11a and an excitation light source 11b.

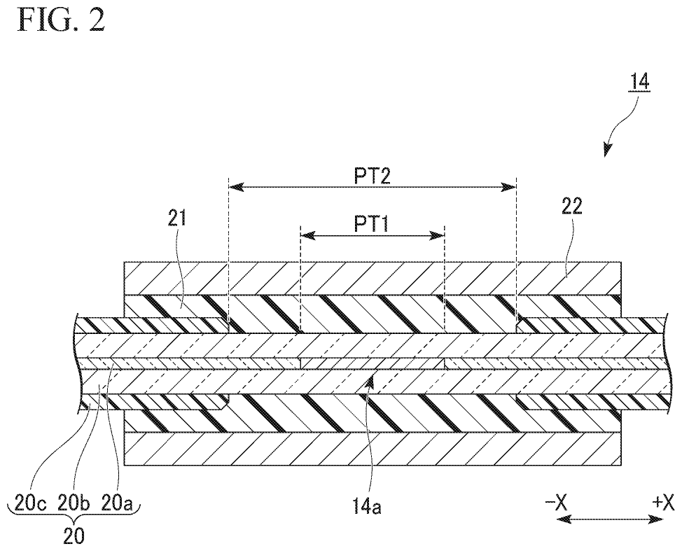

In the following, the longitudinal direction of the optical fiber 20 (see FIG. 2) included in the optical device 14 of the laser apparatus 1 is simply referred to as the “longitudinal direction”. In addition, when viewed from the optical fiber 20, the output end 15 side in the longitudinal direction is referred to as “+X side”, and the resonator 13 side is referred to as “−X side”. Furthermore, the excitation light source 11a side may be referred to as “forward” and the excitation light source 11b side may be referred to as “backward” when viewed from the amplification fiber 13a of the resonator 13.

As shown in FIG. 1, a plurality of excitation light sources 11a and excitation light sources 11b are arranged with the resonator 13 interposed therebetween. The excitation light source 11a emits excitation light (forward excitation light) toward the resonator 13, and the excitation light source 11b emits excitation light (backward excitation light) toward the resonator 13. As the excitation light source 11a and the excitation light source 11b, for example, a laser diode can be used.

The first combiner 12a and the second combiner 12b are arranged on both sides of the resonator 13. The first combiner 12a couples the excitation light emitted by each of the excitation light sources 11a to one optical fiber and directs the excitation light to the resonator 13. The second combiner 12b couples the excitation light emitted by each of the excitation light sources 11b to one optical fiber and directs the excitation light to the resonator 13.

The resonator 13 includes an amplification fiber 13a, a High Reflectivity-Fiber Bragg Grating (HR-FBG) 13b, and an Output Coupler-Fiber Bragg Grating (OC-FBG) 13c. The resonator 13 generates signal light, which is a laser beam, by the excitation light emitted from the excitation light source 11a and the excitation light source 11b.

The amplification fiber 13a has a core to which one or more kinds of active elements are added, a first cladding covering the core, a second cladding covering the first cladding, and a protective coating covering the second cladding. That is, the amplification fiber 13a is a double cladding fiber. As the active element added to the core, for example, a rare earth element such as erbium (Er), ytterbium (Yb), or neodymium (Nd) is used. These active elements emit light in the excitation state. Silica glass or the like can be used as the core and the first cladding. As the second cladding, a resin such as a polymer can be used. As the protective coating, a resin material such as an acrylic resin or a silicone resin can be used.

The HR-FBG (first FBG) 13b is formed in the core of the optical fiber which is fusion-spliced to a front end portion of the amplification fiber 13a. The HR-FBG 13b is adjusted so as to reflect light having a wavelength of signal light with a reflectance of approximately 100% among the light emitted by the active element of the excitation amplification fiber 13a. The HR-FBG 13b has a structure in which a portion having a high refractive index is repeated at regular intervals along the longitudinal direction thereof.

The OC-FBG (second FBG) 13c is formed in the core of the optical fiber fused to a rear end portion of the amplification fiber 13a. The OC-FBG 13c has almost the same structure as the HR-FBG 13b; however, is adjusted to reflect light with a lower reflectance than the HR-FBG 13b. For example, the OC-FBG 13c is adjusted so that the reflectance with respect to the light having a wavelength of the signal light is approximately 10 to 20%.

In the amplification fiber 13a, the signal light reflected by the HR-FBG 13b and the OC-FBG 13c reciprocates in the longitudinal direction of the amplification fiber 13a. The signal light is amplified along with the reciprocation to become laser light. In such a manner, in the resonator 13, the light is amplified and the laser beam is generated. A portion of the laser beam passes through the OC-FBG 13c, reaches the output end 15 via the optical device 14, and is output to the outside.

### (Optical Device)

The optical device 14 includes a slanted FBG 14a and a cladding mode removal portion 14b. The cladding mode removal portion 14b is provided on the +X side and the −X side of the slanted FBG 14a so as to sandwich the slanted FBG 14a in the longitudinal direction. Such an optical device 14 is provided to remove cladding mode light including SRS light propagating in the core 20a (see FIG. 2) of the optical fiber 20 and SRS light propagating in the first cladding 20b of the optical fiber 20.

The optical device 14 is arranged between the resonator 13 and the output end 15. In particular, the optical device 14 is arranged in a region where the residual excitation light of the excitation light emitted from the excitation light source 11a and the excitation light source 11b does not substantially reach. The “where the residual excitation light does not substantially reach” in one or more embodiments is, for example, a portion of the laser apparatus 1 located on the +X side of the second combiner 12b. In the region, since the excitation light is sufficiently absorbed by the core of the amplification fiber 13a forming the resonator 13, it is possible to avoid a situation in which the excitation light is unexpectedly removed by the optical device 14.

Another optical fiber (an optical fiber at a resonator side) is fusion-spliced to an end portion of the −X side of the optical fiber 20 included in the optical device 14, and another optical fiber (an optical fiber at an output side) is fusion-spliced to an end portion of the +X side. Hereinafter, a fusion-spliced portion between the optical fiber 20 and the optical fiber on the resonator side is referred to as a first spliced portion A1, and a fusion-spliced portion between the optical fiber 20 and the optical fiber on the output side is referred to as a second spliced portion A2.

FIG. 2 is a cross-sectional view showing a portion of one or more embodiments of the optical device. The cross-sectional view shown in FIG. 2 shows only the portion where the slanted FBG 14a is formed and the vicinity thereof. In FIG. 2, the portion where the cladding mode removal portion 14b is formed and the vicinity thereof are not shown.

As shown in FIG. 2, the optical device 14 includes an optical fiber 20, a high refractive index material 21, and a heat dissipation member 22. The optical fiber 20 has a core 20a on which a slanted FBG 14a is formed, a first cladding 20b, and a second cladding 20c. That is, the optical fiber 20 is a double cladding fiber having a core 20a on which a slanted FBG 14a is formed.

The optical fiber 20 has a protective coating that covers the second cladding 20c; however, the protective coating is not shown in FIG. 2.

As the core 20a and the first cladding 20b of the optical fiber 20, for example, silica glass or the like can be used. As the second cladding 20c of the optical fiber 20, a resin such as a polymer can be used. That is, a double cladding fiber having a glass cladding formed of silica glass and a polymer cladding formed of a polymer material can be used as the optical fiber 20.

The first cladding 20b covers the core 20a and has a lower refractive index than the core 20a. The second cladding 20c covers the first cladding 20b and has a lower refractive index than the first cladding 20b. As the protective coating (not shown), a resin material such as an acrylic resin or a silicone resin can be used. These resin materials used as protective coatings generally absorb light and generate heat.

The slanted FBG 14a is formed in the core 20a of the optical fiber 20 and is for binding (mode coupling) the SRS light propagating in the core 20a to the first cladding 20b. The slanted FBG 14a is formed by partially irradiating the core 20a of the optical fiber 20 with a processing light ray (ultraviolet laser beam or the like) to modulate the refractive index of the core 20a in the longitudinal direction. In one or more embodiments, in order to form the slanted FBG 14a, the second cladding 20c and the protective coating (not shown) are partially removed, and the core 20a is irradiated with a light beam for processing through the removal portion.

The slanted FBG 14a is configured so as to transmit light in the wavelength band (for example, 1070 nm) of the signal light used as the laser light and release the light in the wavelength band (for example, 1125 nm) of the SRS light from the core 20a toward the first cladding 20b. Although the slanted FBG 14a transmits most of the signal light propagating through the core 20a, it reflects a portion of the signal light. The signal light reflected by the slanted FBG 14a is coupled to the first cladding 20b.

In the slanted FBG 14a, it is desirable that the distance between the refractive index modulation portions in the longitudinal direction be non-uniform. As a result, the wavelength band of the light removed from the core 20a by the slanted FBG 14a increases. In such a manner, the SRS light can be more reliably released toward the first cladding 20b. Therefore, by selectively removing a portion of the SRS light from the core 20a and coupling to the first cladding 20b, it is possible to stabilize the quality of the signal light and prevent damage to the excitation light source 11a and the excitation light source 11b.

The portion from which the second cladding 20c and the like have been removed (removal portion PT2) is covered with the high refractive index material 21 after the slanted FBG 14a is formed. That is, in the first cladding 20b, the outer peripheral surface of the removal portion PT2 including the portion PT1 covering the region where the slanted FBG 14a is formed in the core 20a and from which the second cladding 20c is removed is covered with the high refractive index material 21. In the example shown in FIG. 2, the outer peripheral surface of the second cladding 20c arranged inside the heat dissipation member 22 is also covered with the high refractive index material 21.

Such a high refractive index material 21 is provided to prevent the signal light coupled to the first cladding 20b by the slanted FBG 14a formed on the core 20a from entering the second cladding 20c. As described above, the second cladding 20c is covered with a protective coating, and when the signal light coupled to the first cladding 20b is incident on the second cladding 20c, the protective coating may generate heat and burn out. The high refractive index material 21 is provided in order to prevent such burning out of the protective coating.

As the high refractive index material 21, a resin material having a higher refractive index than the second cladding 20c and having high transparency to signal light and SRS light can be used. The refractive index of the resin material constituting the high refractive index material 21 may be equal to or higher than the refractive index of the first cladding 20b. The principle by which the signal light coupled to the first cladding 20b can be prevented from being incident on the second cladding 20c by providing such a high refractive index material 21 will be described later.

The heat dissipation member 22 is formed longer than the length of the removal portion PT2 in the longitudinal direction, and is provided so as to cover the high refractive index material 21. The heat dissipation member 22 is provided to absorb the SRS light and the signal light through the high refractive index material 21 and dissipate the heat generated by the absorption. The heat dissipation member 22 is, for example, a member having a square cylinder shape or a cylindrical shape, and is formed of, for example, a metal such as aluminum whose inner surface is black anodized. The inner surface of the heat dissipation member 22 is treated with black alumite in order to prevent reflection of the SRS light and the signal light incident on the inner surface.

The cladding mode removal portion 14b shown in FIG. 1 is a so-called cladding mode stripper. Here, the cladding mode stripper is formed by, for example, intermittently removing a portion of the second cladding 20c of the optical fiber 20 and the protective coating (not shown) along the longitudinal direction, and covering the removal portion with a high refractive index resin or the like. Such a cladding mode stripper can remove cladding mode light including SRS light from the inside of the first cladding 20b to a high refractive index resin or the like.

### (Principle of Providing a High Refractive Index Material)

The basic reflection wavelength of the slanted FBG 14a is λ0, and the wavelength difference between the wavelength of the signal light propagating in the core 20a and λ0 is Δλ. In addition, the refractive index of the core 20a is nc, and the refractive index of the high refractive index material 21 is n. The wavelength band of the signal light propagating in the core 20a is, for example, a central wavelength of 1070 nm and a wavelength width of about several tens of nm. Therefore, it should be noted that the above-mentioned wavelength difference Δλ also has a width similar to the above-mentioned wavelength width.

The signal light propagating in the core 20a is coupled to the first cladding 20b when the following equation (1) is satisfied.

Δλ<{(nc−n)/(2·nc)}×λ0 (1)

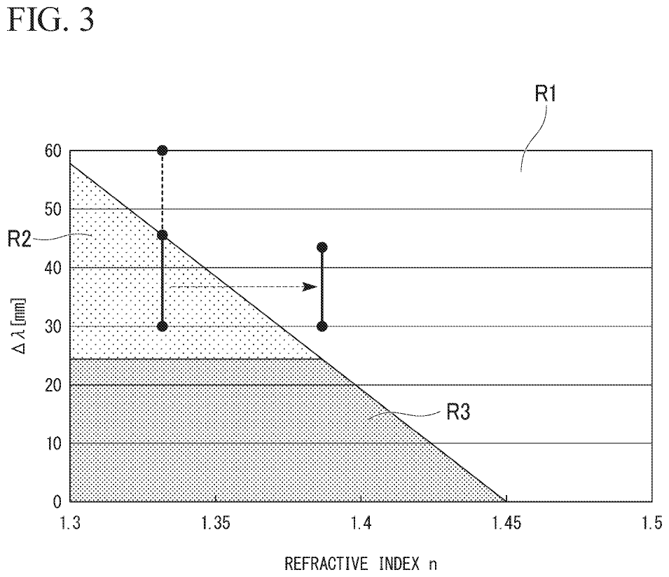

FIG. 3 is a diagram showing the relationship between the wavelength difference Δλ and the refractive index n of the high refractive index material in one or more embodiments. In the graph shown in FIG. 3, the wavelength difference Δλ is on the vertical axis, and the refractive index n of the high refractive index material 21 is on the horizontal axis. In FIG. 3, the basic reflection wavelength λ0 of the slanted FBG 14a is set to 1120 nm. In addition, since the refractive index difference between the core 20a and the first cladding 20b is sufficiently smaller than the refractive index difference between the first cladding 20b and the second cladding 20c, the refractive index nc of the core 20a and the refractive index of the first cladding 20b is 1.45 (refractive index of quartz), and the refractive index of the second cladding 20c is 1.38 (refractive index of polymer material). The graph shown in FIG. 3 is roughly divided into regions R1 and regions R2 and R3 according to the relationship between the wavelength difference Δλ and the refractive index n of the high refractive index material 21.

The region R1 is a region where the above equation (1) is not satisfied, and the regions R2 and R3 are regions where the above equation (1) is satisfied. That is, the region R1 is a region where the signal light propagating in the core 20a is not coupled to the first cladding 20b, and the regions R2 and R3 are regions where the signal light propagating in the core 20a is coupled to the first cladding 20b. Here, the region R2 is a region where the signal light coupled to the first cladding 20b is incident on the second cladding 20c, whereas the region R3 is a region where the signal light coupled to the first cladding 20b propagates through the first cladding 20b without being incident on the second cladding 20c.

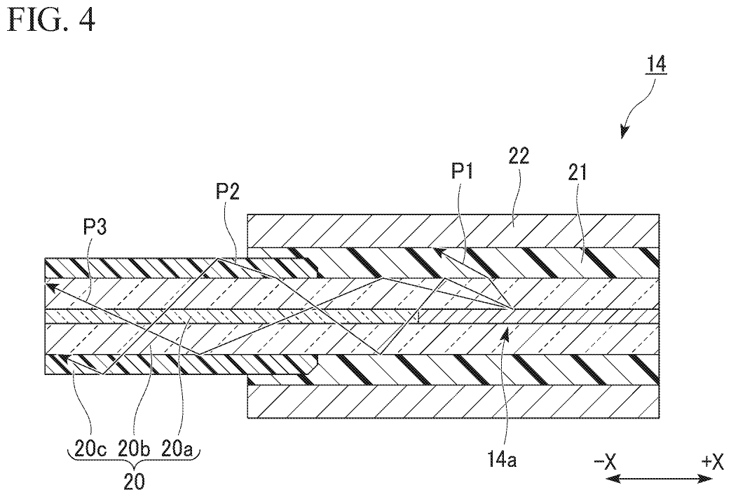

FIG. 4 is a diagram schematically showing a traveling path of signal light reflected by a slanted FBG in one or more embodiments. When the relationship between the wavelength difference Δλ and the refractive index n of the high refractive index material 21 is included in the region R1, the signal light reflected by the slanted FBG 14a is, for example, the traveling path P1 shown in FIG. 4, and the light is incident on the heat dissipation member 22 via the first cladding 20b and the high refractive index material 21.

When the relationship between the wavelength difference Δλ and the refractive index n of the high refractive index material 21 is included in the region R2, the signal light reflected by the slanted FBG 14a is incident on the second cladding 20c when the signal light propagates in the first cladding 20b and reaches the second cladding 20c as the traveling path P2 shown in FIG. 4, for example. When the relationship between the wavelength difference Δλ and the refractive index n of the high refractive index material 21 is included in the region R3, the signal light reflected by the slanted FBG 14a is, for example, the traveling path P3 shown in FIG. 4, and is propagated through the first cladding 20b without being incident on the second cladding 20c.

When the signal light reflected by the slanted FBG 14a passes through the traveling path P1 shown in FIG. 4, the signal light is incident on the heat dissipation member 22 and absorbed. In addition, when the signal light reflected by the slanted FBG 14a passes through the traveling path P3 shown in FIG. 4, the signal light is removed by the cladding mode removal portion 14b shown in FIG. 1. On the other hand, when the signal light reflected by the slanted FBG 14a passes through the traveling path P2 shown in FIG. 4, the protective coating covering the second cladding 20c may generate heat and burn out. In order to prevent burning out due to such heat generation, the relationship between the wavelength difference Δλ and the refractive index n of the high refractive index material 21 may not be included in the region R2 shown in FIG. 3.

Assuming that the refractive index n of the high refractive index material 21 is 1.33, which is lower than that of the second cladding 20c, there is a case that the relationship between the wavelength difference Δλ and the refractive index n of the high refractive index material 21 is included in the region R2 as shown in FIG. 3.

On the other hand, when the refractive index n of the high refractive index material 21 is higher than that of the second cladding 20c, the relationship between the wavelength difference Δλ and the refractive index n of the high refractive index material 21 is not included in the region R2 as shown in FIG. 3. In addition, when the refractive index n of the high refractive index material 21 is higher than that of the first cladding 20b, the relationship between the wavelength difference Δλ and the refractive index n of the high refractive index material 21 is not included in the region R3 as shown in FIG. 3. Therefore, the refractive index n of the high refractive index material 21 is higher than the refractive index of the second cladding 20c.

As described above, in one or more embodiments, in the first cladding 20b, the outer peripheral surface of the removal portion PT2 including the portion PT1 covering the region where the slanted FBG 14a is formed in the core 20a and from which the second cladding 20c is removed is covered with the high refractive index material 21. Thereby, the signal light reflected by the slanted FBG 14a and bound to the first cladding 20b (in particular, the signal light passing through the traveling path P2 shown in FIG. 4) can be effectively removed. As a result, it is possible to prevent burning out due to heat generation of the protective coating (not shown) covering the second cladding 20c.

In addition, in one or more embodiments, the SRS light propagating in the first cladding 20b is also removed by the combination of the slanted FBG 14a provided in the optical device 14 and the cladding mode removal portion 14b. Therefore, it is possible to prevent the protective coating from being irradiated with SRS light and burning out due to heat generation, or the SRS light reaching the excitation light source 11a and the excitation light source 11b and damaging the excitation light source 11a and the excitation light source 11b.

### (Modification Example)

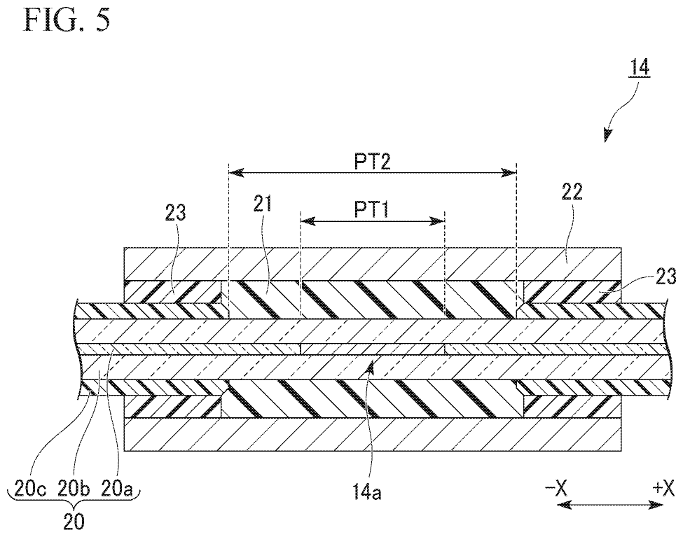

FIG. 5 is a cross-sectional view showing a modification of the optical device according to one or more embodiments. The optical device 14 shown in FIG. 5 includes a reinforcement member 23 provided between the heat dissipation member 22 and the second cladding 20c on the outer sides of both ends of the removal portion PT2 in the longitudinal direction. The reinforcement member 23 enhances the adhesion strength between the heat dissipation member 22 and the second cladding 20c. As the reinforcement member 23, for example, a resin having a refractive index lower than that of the second cladding 20c can be used.

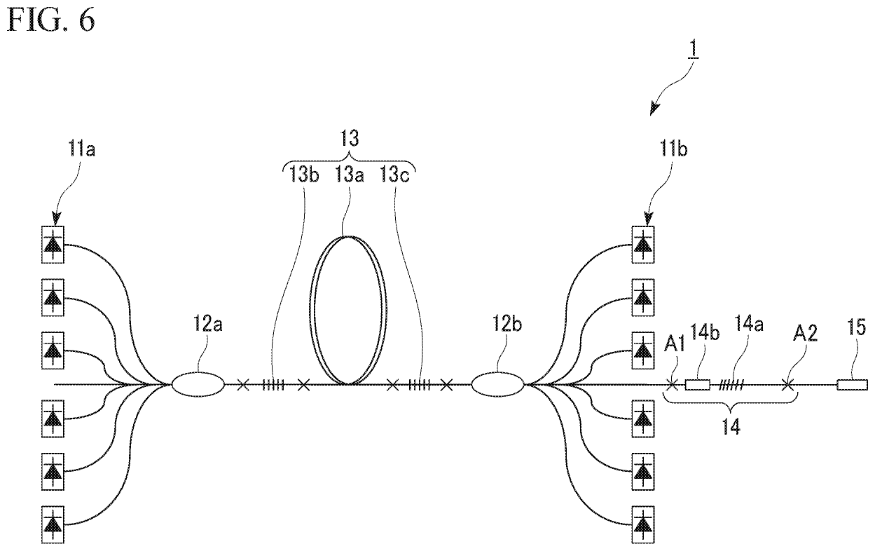

FIG. 6 is a diagram showing a modified example of the laser apparatus according to one or more embodiments. The laser apparatus 1 shown in FIG. 6 includes an optical device 14 in which the cladding mode removal portion 14b is provided only on the −X side of the slanted FBG 14a. That is, in the optical device 14 provided in the laser apparatus 1, the cladding mode removal portion 14b may be provided only on the −X side of the slanted FBG 14a, or on both sides (+X side and −X side) of the slanted FBG 14a.

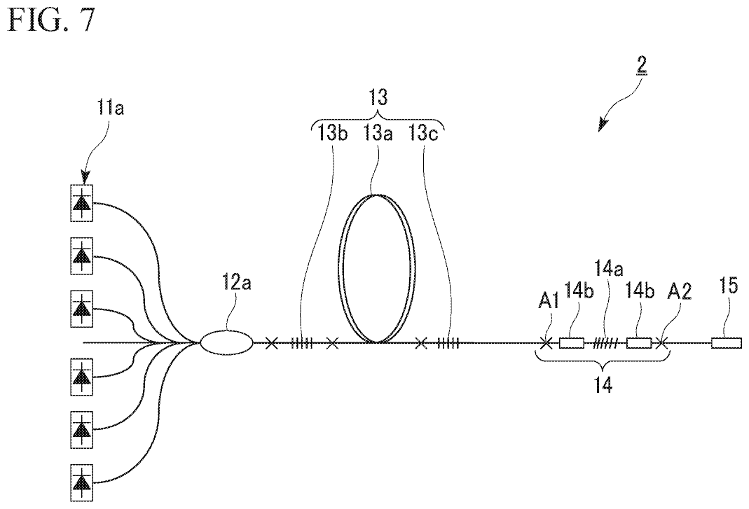

FIG. 7 is a diagram showing one or more embodiments of a laser apparatus. In FIG. 7, the same reference numerals are given to the configurations similar to those shown in FIG. 1. In the following, the description of the same configuration as that described with reference to FIG. 1 will be omitted, and only the different portions will be described.

As shown in FIG. 7, the laser apparatus 2 of one or more embodiments includes an excitation light source 11a, a first combiner 12a, a resonator 13, an optical device 14, and an output end 15. Such a laser apparatus 2 is a one-sided excitation apparatus that does not have an excitation light source (backward excitation light source) 11b. That is, the laser apparatus 2 is a forward excitation fiber laser apparatus.

The resonator 13 includes an amplification fiber 13a and the HR-FBG (first FBG) 13b and the OC-FBG (second FBG) 13c. The optical device 14 is arranged between the OC-FBG 13c forming the resonator 13 and the output end 15. Also in one or more embodiments, in order to prevent the excitation light from being unintentionally removed, the optical device 14 is arranged in a region where the residual excitation light does not substantially reach.

The “region where the residual excitation light does not substantially reach” in one or more embodiments is, for example, a portion of the laser apparatus 2 located on the output end 15 side of the OC-FBG 13c. Since the excitation light is sufficiently absorbed by the core of the amplification fiber 13a forming the resonator 13, such a region is suitable as a position for providing the optical device 14. Although detailed description will be omitted, the laser apparatus 2 of FIG. 7 can also obtain the same effects as those of FIG. 1.

### (Modification Example)

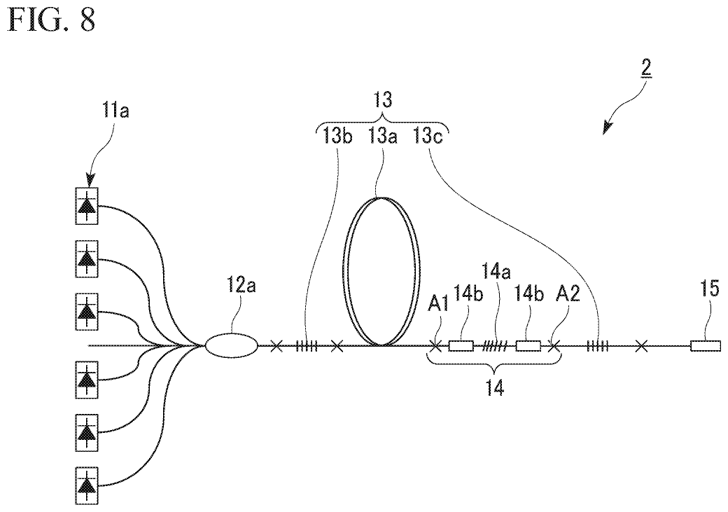

FIG. 8 is a diagram showing a modification of the laser apparatus according to one or more embodiments. The laser apparatus 2 shown in FIG. 8 has a configuration in which the optical device 14 is arranged between the amplification fiber 13a and the OC-FBG 13c, that is, in the resonator 13. Also in the laser apparatus 2 according to the present modification, the optical device 14 is disposed in a region where the excitation light is sufficiently absorbed by the core of the amplification fiber 13a and the residual excitation light does not substantially reach. The same effect as described above can be obtained.

Although the embodiments of the present invention have been described above, the present invention is not limited to the above embodiments and can be freely modified within the scope of the present invention. For example, the laser apparatuses 1 and 2 of one or more embodiments described above have one output end 15; however, an optical fiber or the like may be further spliced to the tip of the output end 15. In addition, a beam combiner may be spliced to the tip of the output end 15 so as to bundle the laser beams from a plurality of laser apparatuses.

In addition, the optical devices 14 provided in the laser apparatuses 1 and 2 of one or more embodiments described above may be used in a Master Oscillator Power Amplifier (MOPA) fiber laser apparatus. Furthermore, the optical device 14 is a laser apparatus such as a semiconductor laser (DDL: Direct Diode Laser) or a disk laser in which the resonator is composed of a non-optical fiber and the laser beam emitted from the resonator is focused on the optical fiber.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF THE REFERENCE SYMBOLS

1, 2: Laser apparatus, 11a, 11b: Excitation light source, 12a: First combiner, 12b: Second combiner, 13: Resonator, 13a: Amplification fiber, 13b: HR-FBG, 13c: OC-FBG, 14: Optical device, 14a: Slanted FBG, 14b: Cladding mode removal portion, 15: Output end, 20a: Core, 20b: First cladding, 20c: Second cladding, 22: Heat dissipation member, 23: Reinforcement material, PT1: Portion, PT2: Removal portion, 21: High refractive index material

1. An optical device, comprising:
a core;
a first cladding that covers the core and has a lower refractive index than the core;
a second cladding that covers the first cladding and has a lower refractive index than the first cladding;
a slanted Fiber Bragg Grating (FBG) that is formed in the core and couples Stimulated Raman Scattering (SRS) light, propagating through the core, to the first cladding; and
a high refractive index material that has a higher refractive index than the second cladding and that covers an outer peripheral surface of a removal portion where the second cladding is removed and a portion of the first cladding that covers a region where the slanted FBG is formed in the core.

2. The optical device according to claim 1, wherein the high refractive index material has a higher refractive index than the first cladding.

3. The optical device according to claim 1, further comprising:
a heat dissipation member that covers the high refractive index material.

4. The optical device according to claim 3, wherein the heat dissipation member dissipates heat generated by absorption of SRS light and signal light through the high refractive index material.

5. The optical device according to claim 3, further comprising:
a reinforcement member disposed between the heat dissipation member and the second cladding outside of both ends of the removal portion in a longitudinal direction of the first cladding, wherein
the heat dissipation member is formed longer than a length of the removal portion in the longitudinal direction of the first cladding.

6. The optical device according to claim 5, further comprising:
a cladding mode removal portion that removes cladding mode light, which includes SRS light coupled from the core to the first cladding by the slanted FBG, from the inside of the first cladding.

7. A laser apparatus, comprising:
an excitation light source that emits excitation light;
a resonator that generates signal light that is laser light by the excitation light emitted from the excitation light source; and
an optical device according to claim 1 that is disposed between the resonator and an output end of the signal light.

8. The laser apparatus according to claim 7, wherein the optical device is disposed in a second region where a residual excitation light of the excitation light emitted from the excitation light source substantially does not reach.

9. The laser apparatus according to claim 8, wherein:
the laser apparatus is a bidirectional excitation fiber laser apparatus, wherein the excitation light source comprises:
a forward excitation light source, and
a backward excitation light source; and
the laser apparatus further comprises:
a first combiner disposed between the resonator and the forward excitation light source;
and a second combiner disposed between the resonator and the backward excitation light source; and
the second region is a portion located on an output end side of the second combiner.

10. The laser apparatus according to claim 8, wherein:
the laser apparatus is a forward excitation fiber laser apparatus;
the resonator comprises:
an amplification fiber in which an active element activated by excitation light is added to the core,
a first FBG disposed between a first end of the amplification fiber and the excitation light source, and
a second FBG disposed between a second end of the amplification fiber and the output end; and
the second region is closer to an output end side than the second FBG.
